(19) United States
(12) Patent Application Publication
(10) Pub. No.: US 2002/0069353 A1
(43) Pub. Date: Jun. 6, 2002

(54) Automated device driver installation

(76) Inventor: R. Doug Smith, Nampa, ID (US)

Correspondence Address: DAN C. HU, TROP, PRUNER & HU , P.C., 8554 KATY FREEWAY , SUITE 100, HOUSTON, TX, 77024, US

(21) Appl. No.: 09/728,105

(22) Filed: Dec. 1, 2000

(51) Int. Cl. G06F 9/00

(52) U.S. Cl. 713/1

(57) ABSTRACT

Embodiments of the present invention include a system and method of configuring a computer system with one or more device drivers, software, or utilities. Embodiments may also include the removable storage media containing instructions to implement system and method embodiments. Embodiments include a configuration information file used by the computer system to install a device driver. Data may be read from the configuration information file to identifying actions to be accomplished and information to be used to install the one or more device drivers.

### TECHNICAL FIELD

The present invention is directed toward a system and method for installing device drivers to configure a computer system. More particularly, the system and method are useful in restoring portions of or an entire computer system device driver configuration to some functional status or to the computer system's status when originally manufactured.

### BACKGROUND OF THE INVENTION

Computer systems are an integration of devices that work together to accomplish computing tasks. Consequently, integration hardware and software must be employed to successfully enable various devices to work together. FIG. 1 illustrates an embodiment of a modem computer system. In the case illustrated, the computer system is a personal computer system. FIG. 1 shows various components and their relation to one another.

FIG. 1 illustrates a processor 1 connected to a North Bridge (or host controller) 2. The North Bridge 2 connects to each of a main memory 3, a graphics controller 4, and a South Bridge (or controller hub) 5. The North Bridge and South Bridge are components of what is typically referred to as the chipset. The chipset is conventionally mounted on the motherboard of a computer system. Note that this is merely one example of a computer system, and other systems may connect components in somewhat different manners. For example, the graphics controller 4 could be integrated into the North Bridge 2, or the North Bridge 2 might also connect directly to a Peripheral Component Interconnect (PCI) bus, or some other bus or device, rather than being connected through the South Bridge 5. As illustrated, a PCI bus 6 is connected to the South Bridge 5. The PCI bus includes PCI slots 7 that are available to accept additional devices that will communicate with the computer system. Devices that may plug into the PCI slots include, but are not limited to, modems, network interface cards, graphics accelerators, and Small Computer System Interface (SCSI) drive adapters. An Industry Standard Architecture (ISA) bus bridge 8 is also shown. The ISA bridge 8 may be used to provide ISA slots to connect legacy ISA devices to the PCI bus and, therefore, the computer system. Similarly, a low pin count interface (LPC I/F) 9 is illustrated connecting a super input/output (Super I/O) 10 to the South Bridge 5. The LPC I/F 9, in addition to the Super I/O 10 may connect other X-Bus devices and legacy ISA devices. The Super I/O 10 illustrated provides connections for various devices such as a keyboard 11, a mouse 12, a floppy disk (FD) 13, a parallel port (PP) 14, a serial port (SP) 15, and an infrared port (IR) 16. FIG. 1 also shows a firmware hub interface (FWH) 17 connected to the South Bridge 5. The FWH 17 is typically used to store and supply nonvolatile instructions such as basic input/output system (BIOS) instructions to the computer system. The BIOS, among other things, manages data flow between a computer's operating system and attached devices. The operating system, however, is the main software component responsible for system signal flow. Well-known operating systems in modem computer systems include such operating systems as various WINDOWS operating systems distributed by Microsoft Corporation, UNIX operating systems derived from the UNIX operating system originally created by AT&T Bell Labs and other similar derivatives such as the open-source operating system LINUX. There are many other operating systems, including operating systems created to operate computers manufactured by Apple Computer, Inc. A universal serial bus (USB) 18 may also be connected to the South Bridge 5. Multiple devices may be connected to the USB 18. Several Integrated Drive Electronics (IDE) drives 19 may be connected to the South Bridge 5. IDE is a standard electronic interface used between a computer and disk storage devices. IDE devices may include hard disk drives, compact disc read-only memory (CD-ROM) drives, and numerous other disk devices. FIG. 1 also shows a system management bus (SMBus) 20 that enables additional devices to be connected to the South Bridge 5. The SMBus 20 is useful in performing management and information gathering functions within the computer system, and may connect one or more devices using the I²C data transmission protocol or another capable protocol.

One of ordinary skill in the art will appreciate that enabling all of these various buses and devices to effectively communicate requires a highly coordinated interaction of resources. The software that performs the coordinating function includes the BIOS and various components of the operating system. These software components must, among other things, allocate resources such as interrupts (IRQs), memory addresses, input/output (I/O) ports, and direct memory access (DMA) channels. Each of these resources is limited, and allocation must therefore be carefully controlled. Typically, additional software components called device drivers are employed to convert the more general input/output instructions of the operating system to messages that the various devices can understand.

Distribution and installation of device drivers can, however, be somewhat complicated. Sometimes device driver software is a part of the operating system. In other instances, device drivers are distributed separately from the operating system. Other complications develop when the device drivers that are supplied with the operating system are outdated or not operational, or more than one compatible device driver is supplied with the operating system. No matter the source of the complication, a user must in some manner determine which device driver or drivers will be used with a particular computer system configuration. Even after a device driver is selected for each device, IRQs, memory addresses, I/O ports, and DMA channels must be determined. This process has been somewhat simplified by the introduction of automatic resource allocation software such as Plug and Play (PnP) software by Microsoft Corporation. PnP software is designed to detect devices that have been added to a computer system, and through a series of algorithms, automatically install device drivers and allocate computer resources to devices such that the computer system operates properly when the PnP routines have executed. A more complete description of certain aspects of PnP is described in U.S. Pat. No. 5,748,980 to Microsoft Corporation, said patent being hereby incorporated by reference in its entirety.

Various WINDOWS operating systems use an information file called the registry to store information such as what hardware is present, what drivers are installed for the attached hardware, how the computer system memory is set up, how applications programs are to be run, etc. The PnP software accesses data in the registry to detect devices and to automatically configure devices.

PnP in practice has proven to be less than a complete solution to the problem of installing device drivers and allocating resources. Generally, PnP is effective with PCI devices and PC cards (e.g. PCMCIA), but either lacks functionality or fails to successfully perform all the necessary functions with certain device drivers, motherboard resident devices, ISA devices, and others. PnP problems may also occur when the BIOS claims resources before the operating system has a chance to detect and allocate resources. Additionally, PnP may fail when all interrupts are used up or appear to the PnP software to be used up. Problems may also arise when hardware is erroneously detected or not detected at all. In short, PnP is often very effective, but has serious limitations with some computer system configurations and software loads.

A computer manufacturer such as Micron Electronics, Inc. provides thousands upon thousands of computer systems to customers on a regular basis. Customer needs and wants vary, and new devices are continually brought to market. Computer systems have, therefore, been supplied over the years with literally thousands of different combinations of devices. It is typical for customers to continue after the purchase of a computer system to add functionality to the system by adding new devices or by adding new software. Such improvements do sometimes exceed the capability of the customer to manage the improvements on the system, or just exceed the capabilities of the system. Additionally, it is inevitable that from time to time devices within a computer system will experience mechanical or electrical failure. Thus, it is necessary on occasion for a customer to reconfigure his or her system, including the reinstallation of device drivers. In more drastic circumstances, the operating system must be reloaded, all of the device drivers must be reinstalled, and the system resources must be completely reconfigured. One conventional way to accomplish this task is with what is called an image disk. Typically, an image disk is a CD-ROM that contains a digital “image” of the computer system's digital data the day it left the factory. This data can be copied to the computer system from the image disk. In some circumstances, the copying is a complete replacement of all of the data that resides on the computer's hard disk drive. Consequently, unless the user has backed-up any data added to the system since it left the factory, the user's added data is lost.

In less drastic circumstances, a technical support representative of the computer manufacturer can diagnose a problem with one or more of the system device drivers. The representative can then describe to the customer how to install the appropriate driver or drivers to correct the problem. However, the installation of various device drivers is quite different. In one circumstance, you may need to delete an entry from the registry using the operating system and a series of directed steps. The system PnP will then properly reinstall the correct device driver, and make system configuration adjustments. With other hardware and software, the user may need to run an executable routine that asks the user a series of questions leading to the installation of the device driver and the resource configuration. Without a representative, however, a customer may not know the answers to the questions necessary to accomplish the configuration. In yet other circumstances, the PnP and/or resource allocation routine may create IRQ, DMA channel, I/O port conflicts, etc. that can only be resolved with experimentation and compromise. This is another task that typically requires intervention from a technical support representative.

All of these factors combine to lead to the conclusion that a lengthy technical support call will result in many circumstances. Long technical support calls are expensive, and therefore undesirable. What is needed is a way of providing customers with a more automatic fix so that a technical support representative may not be needed, or at least may only be required to conduct a short help session. Further, in many circumstances it would be desirable to overcome the limitations of an image disk. Specifically, a less drastic solution that saved more of the customers' data would be preferable. Also, if only specific drivers need to be reinstalled, it would be advantageous to be able to install them more quickly and in a uniform action rather than by executing various dissimilar steps. Some devices and systems provide various ways of installing device drivers. Consequently, it would also be desirable that the experience of the manufacturer regarding a preferred way of configuring the device drivers be conveyed to the end users in an automated fashion. At the same time, it would be still better if the automated process of installing device drivers remained flexible enough to allow the addition of new hardware and device drivers through an operating system programmed processes such as PnP.

### SUMMARY OF THE INVENTION

An embodiment of the invention is a method of configuring a computer system with one or more device drivers. Embodiments of the method include creating a configuration information file containing data that enables the installation of one or more device drivers. The configuration information file may contain data used by the computer system to automatically install a device driver and allocate computer system resources without user intervention. The data may also specify a command to initiate an executable software routine for installing a device driver. Embodiments of the method also include reading data from the configuration information file, the data identifying actions to be accomplished and information to be used to install the one or more device drivers. One or more device drivers are installed based on the data read from the configuration information file.

Another embodiment of the invention is a computer system configured to install one or more device drivers that enable one or more devices to convert input and output instructions of the operating system to messages the devices can process. The system may include at least a motherboard with circuits for transferring electric signals among the devices, a processor connected to the motherboard, a memory device connected to the motherboard, a removable media player connected to the motherboard, and a removable media containing computer data. The removable media data may include a configuration information file containing data that enables the installation of the one or more device drivers, the configuration information file containing data used by the computer system to automatically install a device driver and allocate computer system resources without user intervention, and data specifying a command to initiate an executable software routine for installing a device driver. The data may also include an executable file that initiates a user interface containing one or more selectable buttons associated with one or more device drivers that may be installed on the computer system. The selection of the one or more selectable buttons may cause execution of additional instructions that install device drivers based on the data stored in the configuration information file.

Still another embodiment is a removable media storage device having a configuration information file containing data that enables the installation of one or more device drivers, the configuration information file containing data used by a computer system to automatically install a first device driver and allocate computer system resources without user intervention, and data specifying a command to initiate an executable software routine for installing a second device driver. The device may also have a user interface module that displays a selectable button that enables the selection of a device driver to be installed on the computer system, and an installation module that reads data from the configuration information file, the data identifying actions to be accomplished and information to be used to install the device driver, and installs the device driver based on the data read from the configuration information file.

### BRIEF DESCRIPTION OF THE DRAWINGS

FIG. 1 is a computer system block diagram.

FIG. 2 is a sample information file for embodiments of the invention.

FIG. 3 is a flowchart illustrating embodiments of the invention.

FIG. 4 is a flowchart illustrating embodiments of the invention.

FIG. 5 is an image of an embodiment of a user interface of the invention.

### DETAILED DESCRIPTION OF THE INVENTION

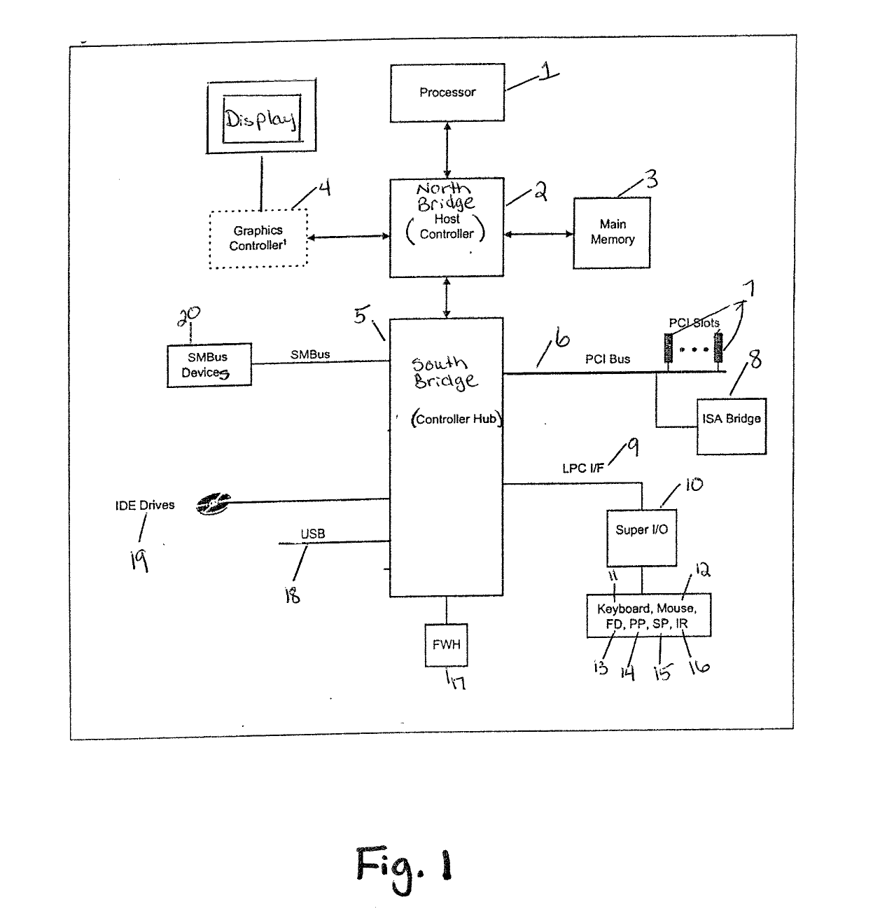

Embodiments of the present invention are directed toward a method of configuring a computer system, including installing the device drivers necessary for proper operation of the computer system. FIG. 1, as discussed above, illustrates a typical hardware configuration for a modem computer system. Device drivers are first stored in one of the IDE drives 19, such as a hard disk drive. When the computer is powered on, the device drivers are loaded into main memory 3 for use by the devices and the operating system.

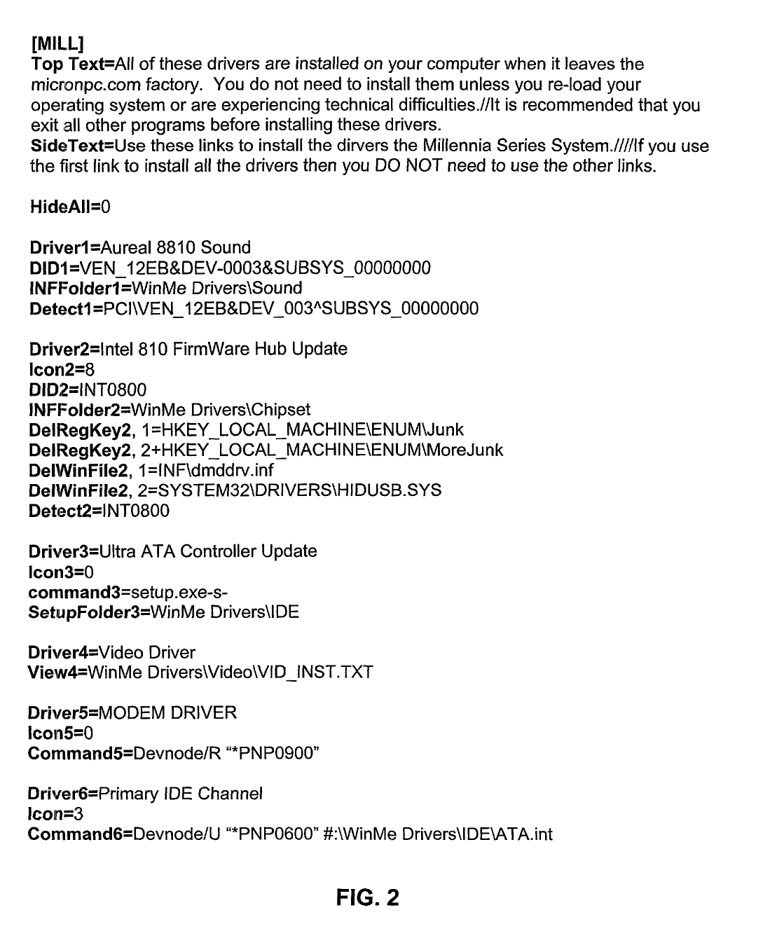

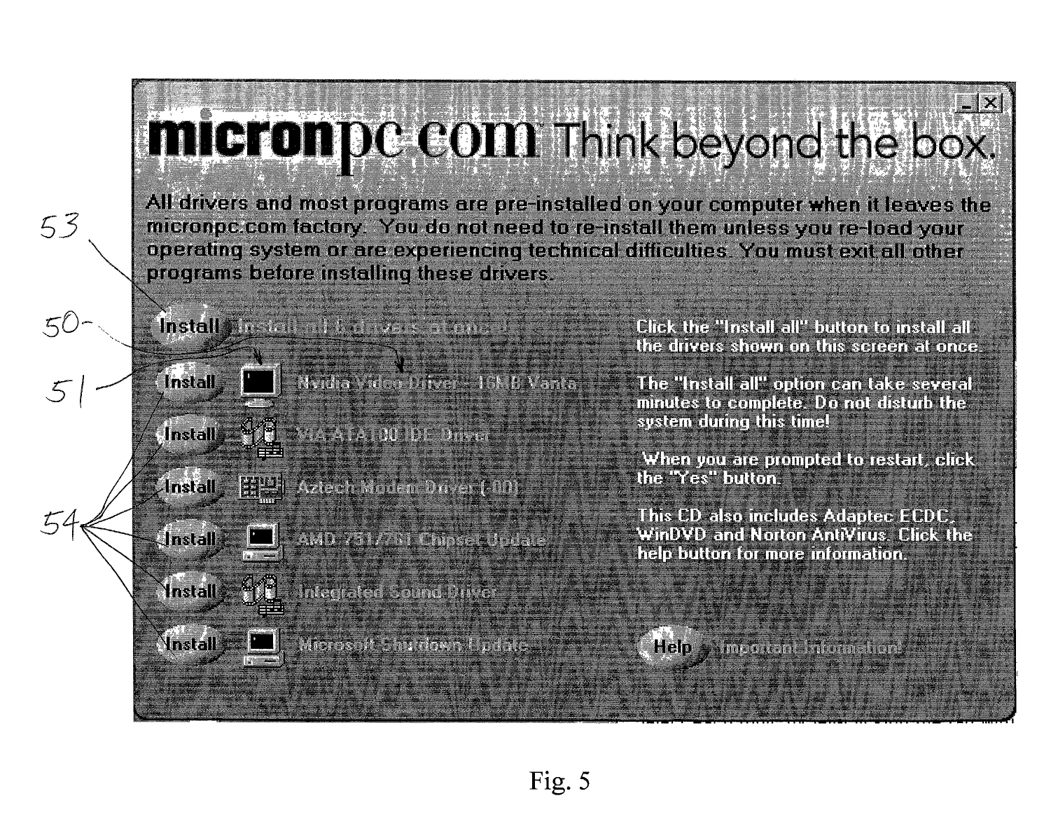

FIG. 2 illustrates a sample information file and includes both data for creating a user interface, as will be discussed below in association with FIG. 5, and data for a configuration information file used to install device drivers. Throughout the present patent application, various value identifiers such as, Driver1, Icon1, DID1, etc. will be referred to generically in reference to their type of value identified as DriverX, IconX, DIDX, etc. It should be understood that these generic value identifiers merely designate characteristics of types of values and that specifically enumerated value identifiers will be used in association with specific data records, e.g., records 1-6 having icons Icon1-Icon6. Note also that the information file illustrated in FIG. 2 is not necessarily a information file that is operable with a specific computer system, but contains a variety of values and types of values that illustrate numerous aspects of embodiments of the invention.

The name of a specific device driver record shown in FIG. 2, for example, is Driver3, Ultra ATA Controller Update. This name is used to refer to a particular device driver when using the driver data. FIG. 5 shows the use of such data. The names in the column below arrow 50 are various names associated with corresponding DriverX values. Similarly, arrow 51 points to a column of icons that would be associated with corresponding icon values designated under values of IconX in the information file.

The device identification value DIDX illustrated in FIG. 2 contains Vendor ID, Device ID, and Subsystem ID information as is typically displayed in the registry of the operating system. In the case of MICROSOFT WINDOWS operating systems, the value is in typically the Enum key of the registry.

The information folder value INFFolderX provides a value that points to a folder that contains information and support files used by the computer system to install various device drivers. The information files will typically be placed in a WINDOWS information folder for execution from that location. That is, if a version of WINDOWS was installed from a local hard disk drive, then the information will be placed in the active source path. Otherwise the information will be placed in an operating system temporary folder by changing the source path in the system registry. An example of the source path value in a WINDOWS system registry is HKEY_LOCAL_MACHINE\SOFTWARE\Microsoft\Windows\Current Version\Setup key. If the information is placed in the operating system temporary folder, then upon a next subsequent boot of the computer system, the value of the source path will be restored to point to the original path, and the operating system temporary folder will be deleted. The present invention includes an executable program that is placed in the WINDOWS folder and in the registry to accomplish these tasks upon reboot of the computer system.

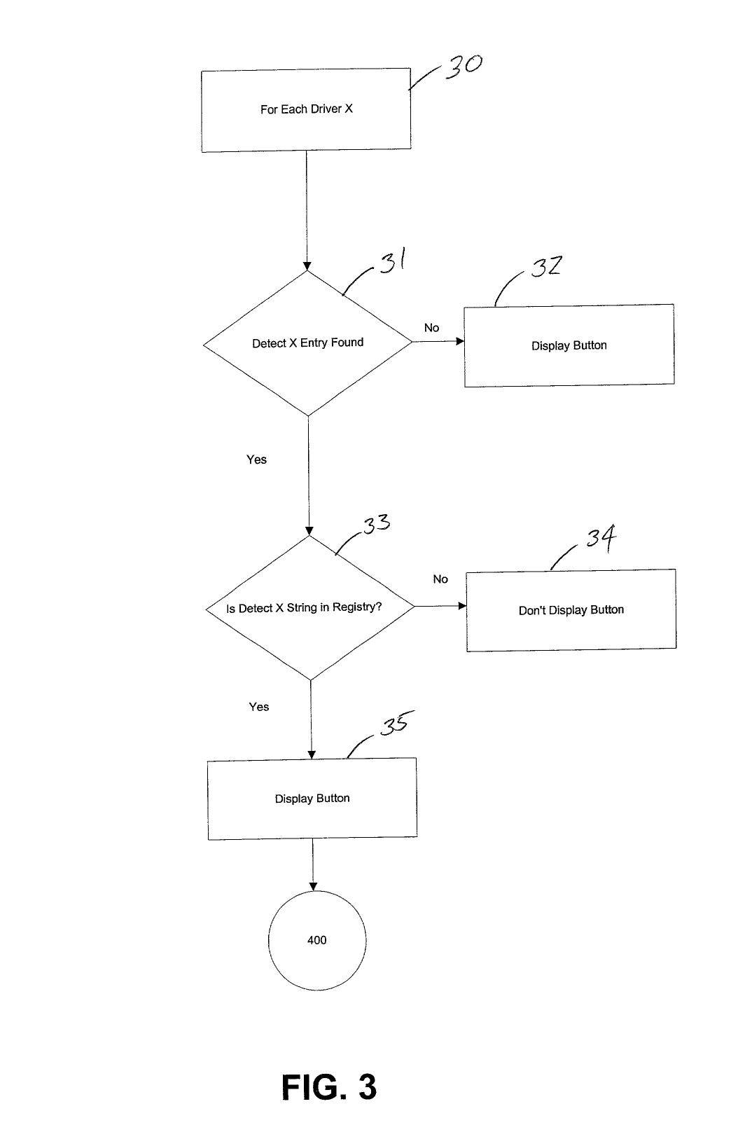

The DetectX value contains Vendor ID, Device ID, and Subsystem ID information as is typically displayed in the registry of the operating system. The DetectX value is used in searching a system information file for an identification string. If the identification string is present, a program of the present invention will generate a selectable button on the user interface. Further description of DetectX is provided below in association with FIG. 3.

The DelRegKeyX and DelWinFileX values are for specifying data to be removed from the information files of the computer system. For instance, DelRegKeyX is used to remove registry entries and DelWinFileX is used to remove files. These values are used to supplement some device driver installation programs' ability to effectively remove all files that may interfere with a subsequent driver installation. As discussed in the background of the present application, this is the type of information that may only be know from specific experience with a device driver and its associated files. Therefore, this is one means of the computer manufacturer automatically preconfiguring a system for a successful device driver installation.

The CommandX value identifies data specifying an executable software routine. A typical executable software routine could be, for example, a patch file, a setup.exe, and install.exe, or some other such file. Embodiments of the invention execute commands to eventually install device drivers. However, in other embodiments, various software utilities or software applications could be installed in a similar manner. The SetupFolderX value is used in combination with the CommandX value to specify a path from which that the program specified in the CommandX value executes.

Another novel aspect of the present invention is a set of utilities that are employed to perform a number of functions useful in the installation of device drivers. In FIG. 2, the utilities are noted as Devnode commands on the command lines of driver records Driver5 and Driver6. Devnode commands operate by making various sets of standard application programming interface calls to the operating system. Devnode commands of embodiments of the present invention are designed to operate under WINDOWS ME and WINDOWS 2000. Referring to FIG. 2, Command5 uses Devnode /R and specifies an identified device on which to operate. The /R variant removes a device from the registry and the Device Manager of WINDOWS. By removing from these locations, aspects of a computer system's automated configuration software, such as PnP, is enabled to install a device driver automatically.

Command6 illustrates Devnode /U. This utility updates a specified resource with an information file from a specified location. In this example, the primary IDE channel “*PNP0600” will be updated from the path from which Devnode.exe started, i.e. symbolized as “#”, plus the remainder of the path specified. That path being \WinME Drivers\IDE\ATA.inf in the example.

Another Devnode command that is not illustrated in FIG. 2 is Devnode /F. This utility runs Devnode.exe and points to a list of Devnode commands in a specified folder.

The configuration information file data described above enables the installation of one or more device drivers as specified in the configuration information file. The data of Driver1 of FIG. 2 is used by the computer system to automatically install a device driver and allocate computer system resources without user intervention. Specifically, this removal of information from the registry prepares an environment where an automatic routine, such as a PnP routine, can act on the computer system to automatically install a device driver and configure other system resources. The configuration information file data may also be used to initiate an executable software routine for installing a device driver. Examples of this are shown in the CommandX values and the Devnode values described above.

A great flexibility of the present invention it is that is capable of installing device drivers by either or both of these methods. Therefore, when a builder of a configuration file knows that a system program like PnP will be superior, the configuration file can be set up to allow PnP to work. One the other hand, if the builder knows that other actions will be necessary, those specific actions can be implemented, e.g. DelRegKeyX and DelWinFileX. Even the specific commands of the Devnode utilities can be employed with the experience of the computer manufacturer and for the easy of operation of the computer system user.

In some circumstances, it is known that there is no way to automatically install a device driver in a computer system. The ViewX value, as shown with Driver4 of FIG. 2 is designed to meet this need. Specifically, the ViewX command provides a path to a file that contains instructions that step a user through manual installation of a device driver. When the manual installation sequence is complete, control is returned to the automated installation program.

FIG. 3 illustrates aspects of an executable file that initiates a user interface containing one or more selectable buttons associated with one or more device drivers that may be installed on the computer system. Returning to FIG. 2 momentarily, The Top Text and Side Text values are merely data files used to build the user interface. The HideAll value is used to determine whether or not an option will be presented to the user to select and install all of the drivers that are presented on the user interface. See button 53 of FIG. 5.

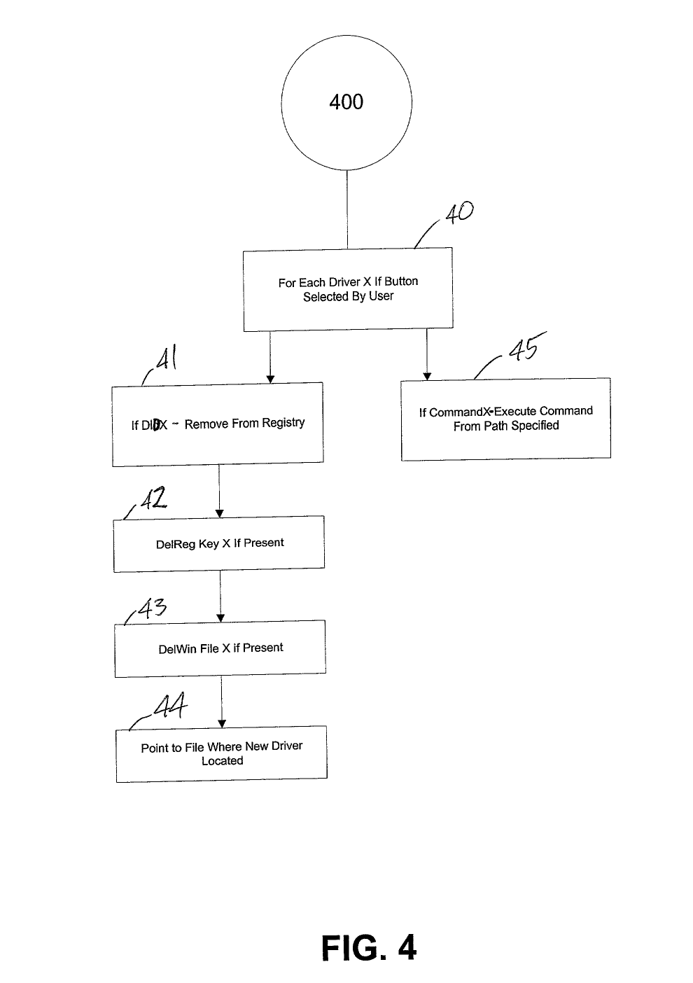

FIG. 3 illustrates an aspect of embodiments of the invention where it is determined whether or not to display a button for each DriverX on the user interface. If a button is displayed, a user will be able to select the button, and a driver for the associated device will be installed. Control begins at block 30. It will be understood by one skilled in the art that control returns to block 30 for each value of X in DriverX until all values of DriverX in the configuration file have been examined. At block 31, the configuration information file record for a DriverX is examined. If there is not a value for DetectX, then a button will be displayed, block 32. This would be the circumstance, for example with Driver3-Driver6 of FIG. 2. If there is a DetectX entry in block 31, then at block 33 it is determined whether the DetectX string listed in the configuration information file is also in a particular location in the computer system registry, block 33. If not, see block 34, no button will be displayed. What has happened in this circumstance is that the device associated with the string is no longer installed or active in the computer system. Therefore, the device does not need to have its device drivers loaded. If in block 33 it is determined that the DetectX string listed in the configuration information file is also in a particular location in the computer system registry, then a button for the associated device driver is displayed on the user interface, block 35. When each DriverX has been evaluated in this way, control is passed to 400, and FIG. 4.

FIG. 4 illustrates the selection of the one or more of the selectable buttons and the resulting execution of additional instructions that install device drivers based on the data stored in the configuration information file. At block 40 a determination is made regarding whether a user has selected a displayed button in order to have a device driver installed for the associated device.

If the displayed button was selected and there was a DIDX associated with the record, the specified string will be removed from a portion of the registry, thereby enabling further action by the operating system. See block 41. Such action might include implementation of a PnP routine. As specified in the configuration information file, additional data may need to be deleted from the operating system files, as described above in association with DelRegKeyX and DelWinFileX. Therefore, at blocks 42 and 43, DelRegKeyX and DelWinFileX data is deleted if strings are present for those values.

Block 44 illustrates pointing to a file where a new device driver to be installed is located. The discussion above regarding INFFolderX provides additional detail about the use of the file pointing function.

If the displayed button was selected and there was a CommandX associated with the record, the command should be executed from the path specified in association with the command. See block 45. The path specification may be accomplished through the SetupFolderX value described above.

FIG. 5 illustrates an embodiment of the user interface of the invention. Various aspects of the user interface have been described above in association with functional descriptions of embodiments of the invention. The user interface includes both informational text, device names which are in a column below arrow 50, device icons which are in a column below arrow 51, an install all button 53 to install all device drivers listed, and individual install buttons 54.

From the foregoing it will be appreciated that, although specific embodiments of the invention have been described herein for purposes of illustration, various modification may be made without deviating from the spirit and scope of the invention. Accordingly, the invention is not limited except as by the claims.

What is claimed is:

1. A method of configuring a computer system with one or more device drivers comprising:
creating a configuration information file containing data that enables the installation of one or more device drivers, the configuration information file containing data used by the computer system to automatically install a device driver and allocate computer system resources without user intervention, and data specifying a command to initiate an executable software routine for installing a device driver;
reading data from the configuration information file, the data identifying actions to be accomplished and information to be used to install the one or more device drivers; and
installing the one or more device drivers based on the data read from the configuration information file.

2. The method of configuring a computer system of claim 1 wherein the act of creating a configuration information file includes creating data used by the computer system to automatically install a device driver by implementing a Plug and Play software routine.

3. The method of configuring a computer system of claim 1 wherein the act of creating a configuration information file includes listing an identification string for a device.

4. The method of configuring a computer system of claim 1 wherein the act of creating a configuration information file includes listing a file identifier for an information folder where information about a device is stored.

5. The method of configuring a computer system of claim 1 wherein the act of creating a configuration information file includes listing a file identifier, the corresponding file to be deleted prior to a new device driver being installed.

6. The method of configuring a computer system of claim 1 wherein the act of creating a configuration information file includes listing a command for initiating the executable software routine for installing a device driver.

7. The method of configuring a computer system of claim 6 wherein the act of creating a configuration information file includes listing at least a portion of a path to the command.

8. The method of configuring a computer system of claim 1 wherein the act of reading data includes reading an identification string.

9. The method of configuring a computer system of claim 1 wherein the act of reading data includes reading an information folder where information about a device is stored.

10. The method of configuring a computer system of claim 1 wherein the act of reading data includes reading a file identifier, the corresponding file to be deleted prior to a new device driver being installed.

11. The method of configuring a computer system of claim 1 wherein the act of reading data includes reading a command for initiating the executable software routine for installing a device driver.

12. The method of configuring a computer system of claim 11 wherein the act of reading data includes reading at least a portion of a path to the command.

13. The method of configuring a computer system of claim 1 wherein the act of installing a device driver includes searching a system information file for an identification string, and if the identification string is present, removing the identification string from the system information file.

14. The method of configuring a computer system of claim 13 wherein the act of searching a system information file includes searching a system registry.

15. The method of configuring a computer system of claim 13 wherein the act of installing a device driver includes permitting the computer system to automatically install a device driver and allocate computer system resources after the identification string is removed from the system information file.

16. The method of configuring a computer system of claim 1 wherein the act of installing a device driver includes pointing an installation program to an information folder where information about a device is stored.

17. The method of configuring a computer system of claim 16 wherein the act of installing a device driver includes placing information found in the information folder in an operating system folder from which the operating system can use the information to install a device driver.

18. The method of configuring a computer system of claim 17 wherein if the operating system was installed from a local hard disk drive, then the information will be placed in a system registry, otherwise the information will be placed in an operating system temporary folder by changing the source path in the system registry, and if the information is placed in the operating system temporary folder, then upon a next subsequent boot of the computer system, the value of the source path will be restored to point to the original path, and the operating system temporary folder will be deleted.

19. The method of configuring a computer system of claim 1 wherein the act of installing a device driver includes deleting a file associated with a device driver that is being removed from the computer system.

20. The method of configuring a computer system of claim 1 wherein the act of installing a device driver includes executing a command for initiating the executable software routine for installing a device driver, the method of configuring further including sufficient instructions to cause the computer system to complete installation of the device driver.

21. The method of configuring a computer system of claim 1 wherein the act of installing a device driver includes executing a command that is a utility to remove a device driver by making a set of standard application programming interface calls.

22. The method of configuring a computer system of claim 1 wherein the act of installing a device driver includes executing a command that is a utility to update a device driver by making a set of standard application programming interface calls.

23. The method of configuring a computer system of claim 1 wherein the act of installing a device driver includes executing a command that is a utility to point to a file containing other commands for installing a device driver, the utility making a set of standard application programming interface calls.

24. The method of configuring a computer system of claim 1 further comprising presenting a user interface containing one or more selectable buttons that enable the selection of one or more device drivers to be installed on the computer system.

25. The method of configuring a computer system of claim 24 wherein activating a selectable button enables installation of multiple device drivers.

26. The method of configuring a computer system of claim 24 wherein the act of installing a device driver includes searching a system information file for an identification string, and if the identification string is present, generating the selectable button on the user interface.

27. A computer system configured to install one or more device drivers that enable one or more devices to convert input and output instructions of the operating system to messages the devices can process comprising:
a motherboard with circuits for transferring electric signals among the devices;
a processor connected to the motherboard;
a memory device connected to the motherboard;
a removable media player connected to the motherboard; and
a removable media containing computer data comprising:
a configuration information file containing data that enables the installation of the one or more device drivers, the configuration information file containing data used by the computer system to automatically install a device driver and allocate computer system resources without user intervention, and data specifying a command to initiate an executable software routine for installing a device driver, and
an executable file that initiates a user interface containing one or more selectable buttons associated with one or more device drivers that may be installed on the computer system, the selection of the one or more selectable buttons causing execution of additional instructions that install device drivers based on the data stored in the configuration information file.

28. The computer system of claim 27 further comprising an autorun file that automatically runs the executable file when the removable media is inserted into the removable media player.

29. The computer system of claim 27 wherein the removable media is an optical media disk.

30. A removable media storage device comprising:
a configuration information file containing data that enables the installation of one or more device drivers, the configuration information file containing data used by a computer system to automatically install a first device driver and allocate computer system resources without user intervention, and data specifying a command to initiate an executable software routine for installing a second device driver;
a user interface module that displays a selectable button that enables the selection of a device driver to be installed on the computer system,
an installation module that:
reads data from the configuration information file, the data identifying actions to be accomplished and information to be used to install the device driver; and
installs the device driver based on the data read from the configuration information file.

31. The removable media storage device of claim 30 wherein the configuration information file includes data used by the computer system to automatically install a device driver by implementing a Plug and Play software routine.

32. The removable media storage device of claim 30 wherein the configuration information file includes an identification string for a device.

33. The removable media storage device of claim 30 wherein the configuration information file includes a file identifier for an information folder where information about a device is stored.

34. The removable media storage device of claim 30 wherein the configuration information file includes a file identifier, the corresponding file to be deleted prior to a new device driver being installed.

35. The removable media storage device of claim 30 wherein the configuration information file includes listing a command for initiating the executable software routine for installing a device driver.

36. The removable media storage device of claim 35 wherein the configuration information file includes listing at least a portion of a path to the command.

37. The removable media storage device of claim 30 wherein activating a selectable button enables installation of multiple device drivers.

38. The removable media storage device of claim 30 wherein installing the device driver includes searching a system information file for an identification string, and if the identification string is present, generating the selectable button on the user interface.

39. The removable media storage device of claim 30 wherein installing the device driver includes permitting the computer system to automatically install a device driver and allocate computer system resources after an identification string is removed from the system information file.

40. The removable media storage device of claim 30 wherein installing the device driver includes pointing the program of the installation module to an information folder where information about a device is stored.

41. The removable media storage device of claim 40 wherein installing the device driver includes placing information found in the information folder in an operating system folder from which the operating system can use the information to install a device driver.

42. The removable media storage device of claim 41 wherein if the operating system was installed from a local hard disk drive, then the information will be placed in a system registry, otherwise the information will be placed in an operating system temporary folder by changing the source path in the system registry, and if the information is placed in the operating system temporary folder, then upon a next subsequent boot of the computer system, the value of the source path will be restored to point to the original path, and the operating system temporary folder will be deleted.

43. The removable media storage device of claim 30 wherein installing the device driver includes deleting a file associated with a device driver that is being removed from the computer system.

44. The removable media storage device of claim 30 wherein installing the device driver includes executing a command for initiating the executable software routine for installing a device driver, the installation module further including sufficient instructions to cause the computer system to complete installation of the device driver.

45. The removable media storage device of claim 30 wherein installing the device driver includes executing a command that is a utility to remove a device driver by making a set of standard application programming interface calls.

46. The removable media storage device of claim 30 wherein installing the device driver includes executing a command that is a utility to update a device driver by making a set of standard application programming interface calls.

47. The removable media storage device of claim 30 wherein the act of installing a device driver includes executing a command that is utility to point to a file containing other commands for installing a device driver, the utility making a set of standard application programming interface calls.
